(19) United States
(12) Patent Application Publication
(10) Pub. No.: US 2016/0191483 A1
(43) Pub. Date: Jun. 30, 2016

(54) Universal Connector

(71) Applicants: Donald Larson, Addison, TX (US); Navid Mitchell, Rio Rancho, NM (US); Nicholas Padilla, Las Cruces, NM (US)

(72) Inventors: Donald Larson, Addison, TX (US); Navid Mitchell, Rio Rancho, NM (US); Nicholas Padilla, Las Cruces, NM (US)

(21) Appl. No.: 14/802,689

(22) Filed: Jul. 17, 2015

Related U.S. Application Data
(60) Provisional application No. 62/026,504, filed on Jul. 18, 2014.

(51) Int. Cl. H04L 29/06

(52) U.S. Cl. CPC H04L 63/08; H04L 63/0428

(57) ABSTRACT

A Universal Connector (“UC”) ecosystem includes encrypted twin (first and second) communications stacks configured to supervise persistent connectivity with distributed data collection points within an Internet of Things. Everything that interacts with the UC ecosystem follows a simple registration process: (1) devices participate on the first stack by requesting to be adopted by logging into the Cloud Service (the “knowledge” factor, they phone home); (2) if validated as an ecosystem device, it is placed into the adoption process and proceeds to the next layer of authentication; and (3) the second stack represents applications (mobile and web) that continue the adoption process for the user/owner (the possession factor). The owner creates an account, then associates the device to the account created, and if all authentication factors are confirmed, the device is adopted and registered to the user/owner completing the adoption process.

### CROSS-REFERENCE TO RELATED APPLICATIONS

This application claims the benefit of U.S. Provisional Application No. 62/026,504, filed Jul. 18, 2014, which application is hereby incorporated herein by reference, in its entirety.

### TECHNICAL FIELD

The invention relates generally to a universal connector and, more particularly, to a universal connector for data communications.

### BACKGROUND

Technology should be as simple as turning on a lamp. Plug the lamp in, flip the power switch, the lamp turns on and light fills the room. The evolution of technology should allow for performing more complex tasks via intelligent devices and less user interaction. Like the illumination of the lamp, once connected, technology should proactively inform the user of what is happening. Information Technology professionals and consumers expect and deserve a plug and play (PnP) experience.

Fog computing, the paradigm extending cloud computing and services to the edge of a network, describes how technology should work in order to achieve plug and play. Machine to Machine (M2M) only defines the methods of connectivity, communication and standards, but like fog computing, both fall short of delivering a simple plug-and-play experience.

### SUMMARY

Accordingly, the present invention provides a Universal Connector (hereinafter “UC”) having an enterprise grade architecture which is a fully modular, scalable, and simple-to-use communications stack. The UC offers open APIs, firewall navigation (no port forwarding), persistent connectivity and security, deployable within a “white label” configuration (service-oriented architecture or private enterprise application implementations). This innovative service delivers network preservation via data analytics, with a calculable return on investment including a reduction in storage, data payload, and installation costs.

The UC enables the consumer or industrial Internet (Fog). The UC's Fog enablement benefits include device and compute proximity to end-users, dense device distribution, support for mobility, and heterogeneous platform interoperability. Services are hosted at the network edge or within the device. Fog computing reduces service latency while supporting Internet of Things (IoT) applications that demand real-time and/or predictable latency in industrial, commercial, and residential settings.

The overall UC architecture vertically defends against malicious incursions and is immune to the challenges facing M2M and Fog installations related to data volume, variety, and velocity. The UC ecosystem includes an encrypted twin communications stack (FIG. 1) supervising persistent connectivity with distributed data collection points within the Internet of Things. Basically, everything that interacts with the UC ecosystem follows a simple registration process: devices participate on one stack by requesting to be adopted by logging into the Cloud Service (the knowledge factor, they phone home); if validated as an ecosystem device, it is placed into the adoption process and proceeds to the next layer of authentication; the other stack represents applications (mobile and web) continue the adoption process for the user/owner (the possession factor). The owner creates an account, then associates the device to the account created, and if all authentication factors are confirmed, the device is adopted and registered to the user/owner completing the adoption process.

The IoT may include, without limitation, industrial automation, sensor-device networks, and actuators. The UC will converge IoT networks from multiple management domains into subscription service tasks.

When an out of the box UC embedded device is powered up and network-connected, it tunnels through the network, typically without any firewall changes to the UC enabled cloud, registers, and tunnels back to the device (FIG. 6). All encryption is Public Key Encryption (PKE) which can be additionally hardened if needed. The device awaits registration and programming.

Functionally, once the UC application resides on any device with an embedded operating system (meeting minimal standards) or any HTTP enabled device within the same LAN as the UC-enabled device, a symbiotic relationship is enabled. A reciprocal UC application resides within the cloud service. Via a suite of APIs, the UC sends/receives messages to a native smartphone application, network management center, and/or customer dashboard.

Architecture

The UC is not limited to one industry, device, or application. The open, simple, and scalable architecture allows organizations to incorporate the UC when there is a need to manage, measure, control, or capture data from edge devices. Whether one to many, many to one, or many to many, network architects need to keep in mind the management of bandwidth, device configuration/programming, installation, access, management, and data storage, when designing their networks.

Subscriptions: The UC provides key building blocks to assemble, deploy and scale applications across multiple platforms, including in a mobile environment, instantly and securely around the world. See FIG. 1 and the following discussion.

Applications

The Universal Connector's role in a diverse manufacturing organization:

1) The Universal Connector creates a single development platform across all organizations.

2) This advanced communications ecosystem is the foundation for current and future devices, including integration with third party products, due to an open, simple and scalable architecture.

3) A secure and enterprise grade ecosystem addresses the potential for rogue machine incursions, aligning the needs of plant and IT management.

4) Maintaining one technology is more cost effective than multiple proprietary solutions and reduces training, installation, and monitoring overhead.

The UC is a device-agnostic, cloud-based application, revolutionizing communications between devices.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 exemplifies a preferred inbound/outbound communications stack and the application outbound/inbound communications stack the fire micro kernel uses to communicate with the flint services represented in FIGS. 2 and 3 below;

FIG. 2 is a diagram that illustrates a Fire Micro Kernel layer of the Connector Services;

FIG. 3 is a diagram that illustrates a Cloud Connector Service Network Topology layer of the Connector Services;

FIG. 4 exemplifies a sequence for processes that are long living;

FIGS. 5A and 5B exemplify an initialization sequence; and

FIG. 6 exemplifies eDNA.

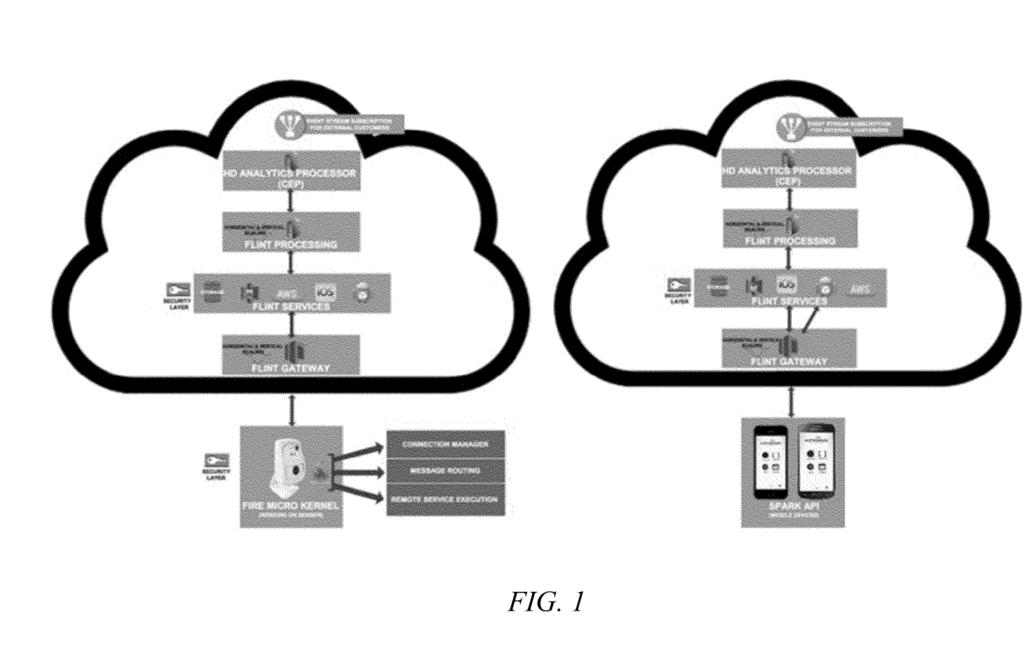

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. Additionally, as used herein, the term “substantially” is to be construed as a term of approximation.

It is noted that, unless indicated otherwise, functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

### Cloud and Edge Devices

The connector services are comprised of two primary layers, the Cloud Services (Flint Cloud Applications) and the Edge Device (Fire application). At the lowest level the Flint Cloud Applications and Fire Application are built on a lightweight message passing infrastructure. All business services are built around the message passing infrastructure. The Fire application's core is a modular micro kernel that supports connection management, message routing, and remote service execution. This micro kernel can be repurposed to control any device that runs Windows, Unix, Linux and supports the minimum hardware requirements. The Flint Cloud Applications are modular and designed to scale independently. The Flint Cloud Applications are broken into three primary categories, Device Communication, Message Processing, and Business Services. The applications responsible are the Flint Gateway, Flint Message Processor/HD Analytics Processor, and the Flint Service respectively. All Flint applications share a common code base that contains business domain logic and the aforementioned message passing core. Here is a list of each of the Flint Applications and their high level responsibilities.

Flint Gateway
Provides a secure communications tunnel between the Fire Micro Kernel and all Flint Applications.
Provides low-level message routing for connected devices running the Fire Micro Kernel.
Provides horizontal or vertical scaling of server resources.

Flint Message Processor
Provides inbound message routing and processing for devices running the Fire Micro Kernel.
Provides inbound message processing logic for defined business use cases.
Provides business level notifications in response to inbound device events.
Provides specialized routing to the HD Analytics Processor application.
Provides horizontal or vertical scaling of server resources.

HD Analytics Processor
Extends the basic message processor to enable Complex Event Processing (CEP). Event processing is a method of tracking and analyzing (processing) streams of information (data) about things that happen (events),^{[1]} and deriving a conclusion from them. Complex event processing, or CEP, is event processing that combines data from multiple sources^{[2]} to infer events or patterns that suggest more complicated circumstances.
   Enables CEP modules to be easily added as new analytics requirements are defined.
Provides Event Stream Subscription functionality.
   Event Subscriptions allow external customers to subscribe to Event Streams.
   Event Streams can be produced directly from the Fire Micro Kernel devices.
   Event Streams can be produced as output from any defined CEP module.
   Provides Event Stream manger that allows new event streams to be easily implemented.
Uses Camel to provide limitless input and output options for event consumption and delivery.
   Existing input/output sources supported http://camel.apache.org/component.html
Provides vertical scaling of server resources.

Flint Service
Provides business logic and business rule functionality.
   Here are some examples of functionality supported. This is not a in any way a complete list. That would be much longer;)
   Provides management and registration functionality for devices running the Fire Application.
   Provides user management and registration functionality.
   Provides AWS S3 integration for data storage and retrieval.
   Provides security layer that allows integrators to choose how access should be granted to connected devices.
Provides full API (code name Spark) for interaction with all connected devices.
   Spark can be used via REST or native language libraries.
   Native language libraries are provided for Java/Android and iOS.
Uses message routing core to enable remote service execution on devices running the Fire Micro Kernel.
   This interface is not exposed directly to the Spark API but used internally during business processing.
Provides all existing Mobile Application cloud functionality.
Provides horizontal or vertical scaling of server resources.

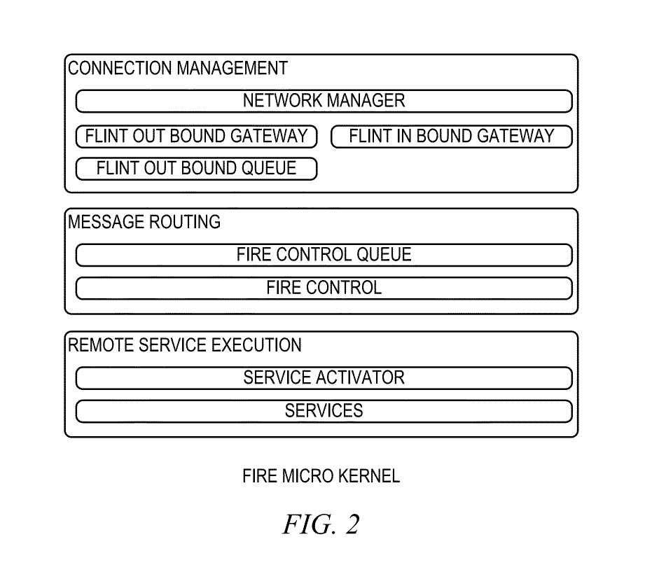

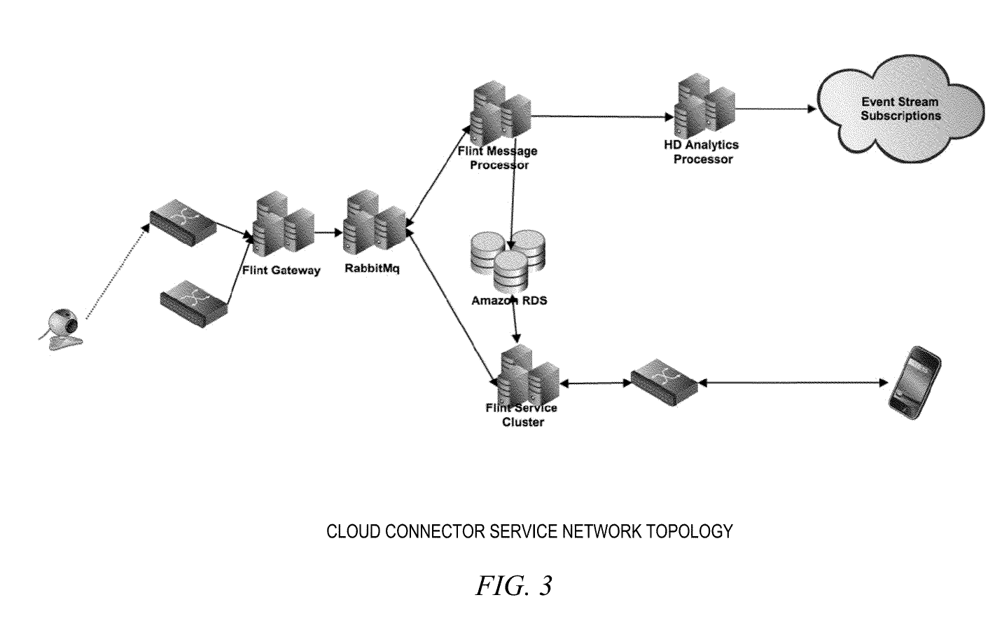

FIGS. 2 and 3 exemplify two primary layers of the Connector Services, namely, (1) a Fire Micro Kernel (FIGS. 2) and (2) a Cloud Connector Service Network Topology (FIG. 3).

### Logic Behind Edge Devices

Edge Devices are devices that are supported by the Universal Connector and the mTHINX Cloud ecosystem (hereinafter, “mCloud”). Edge Devices range in their function and are loosely defined as any device with an operating system running executable software code having the ability to connect to a wired or wireless network. In order for an Edge Device to be effective it must be able to connect from any network and function from within a secure ecosystem that allows for complete control of the device from any mobile or fixed computing device. To enable this, the device must maintain a connection as well as re-establish a connection to the network. The following is the sequence a device will take when the Universal Connector process is started. Edge Devices will be registered with mCloud if and only if mCloud can validate that the device should be able to connect. This allows devices that have not been added to the mCloud services to be placed into a hibernation mode to save bandwidth. In this mode devices will wait for a short period before attempting another connection to mCloud.

Universal Connector (UC)

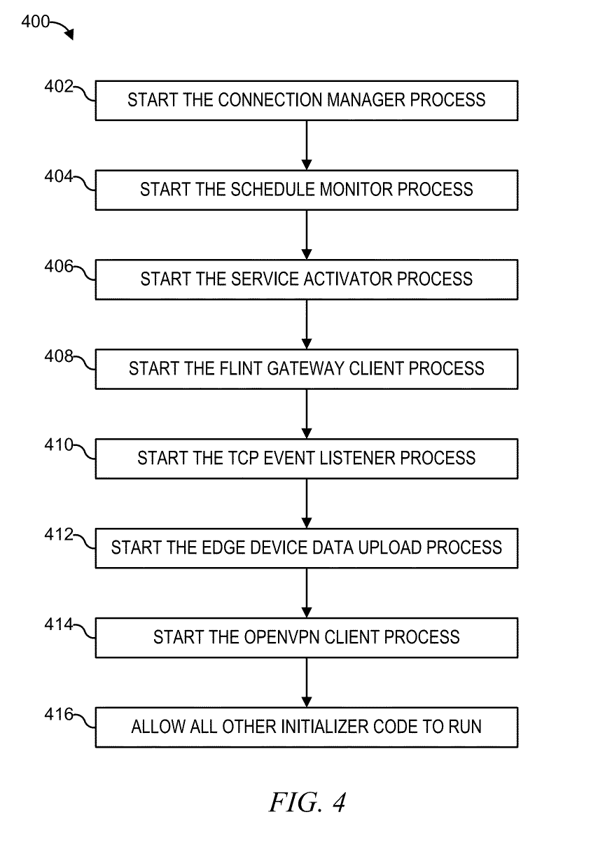

The UC at the core is preferably currently a C++ application providing several functions. It initializes Edge Devices and performs the following sequence, also depicted by FIG. 4, for processes that are long living, i.e. have their own thread:

1) (step 402) Start the Connection Manager process, which will be initialized in a later step.

2) (step 404) Start the Schedule Monitor process.
a) This process allows users to have different processes started or stopped based on their schedule.
b) By default everything is on, creating a schedule will turn on the desired process only during the specified time period.

3) (step 406) Start the Service Activator process.
a) This process wait for messages passed down from the Flint Gateway Client
b) Then calls the correct functionality based on the message.

4) (step 408) Start the Flint Gateway Client process.
a) This process retrieves messages from mCloud and then broadcasts them to any other internal processes to handle it.

5) (step 410) Start the TCP Event Listener process (only on event driven devices.)
a) This process gets configured to listen for events being triggered on the device itself.
b) This process will also send these events to mCloud for routing and/or aggregation.

6) (step 412) Start the Edge Device Data Upload process.
a) This process will take data that is gathered on the device and upload it to storage location.
b) This is so that Users can access this data in an easy way.

7) (step 414) Start the OpenVPN Client process.
a) This process will start OpenVPN and manage the connection, restarting the process if necessary.
b) Please see the OpenVPN document for more information. This process is only activated if the device supports OpenVPN.

8) (step 416) Lastly, we allow all other Initializer code to run.
a) This code expects an already started device, so that is why it happens after all other processes are started.

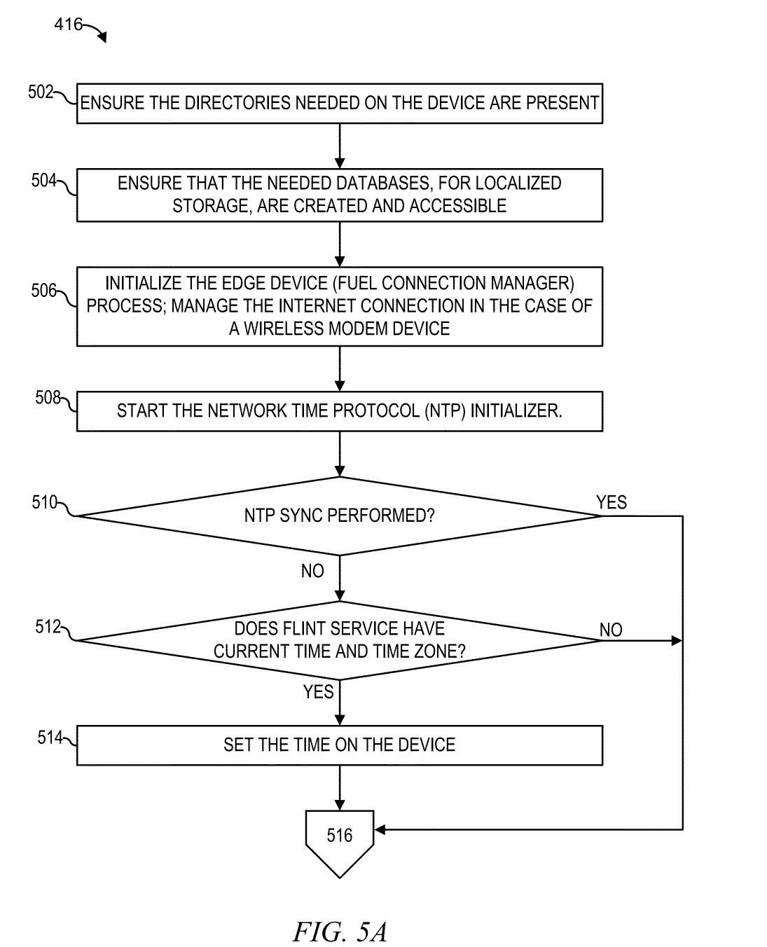

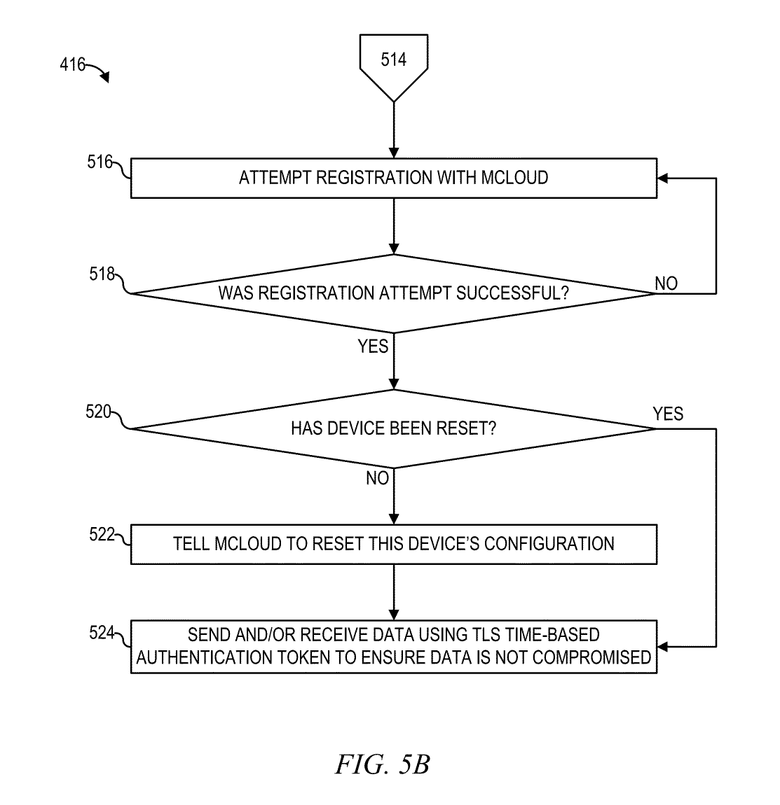

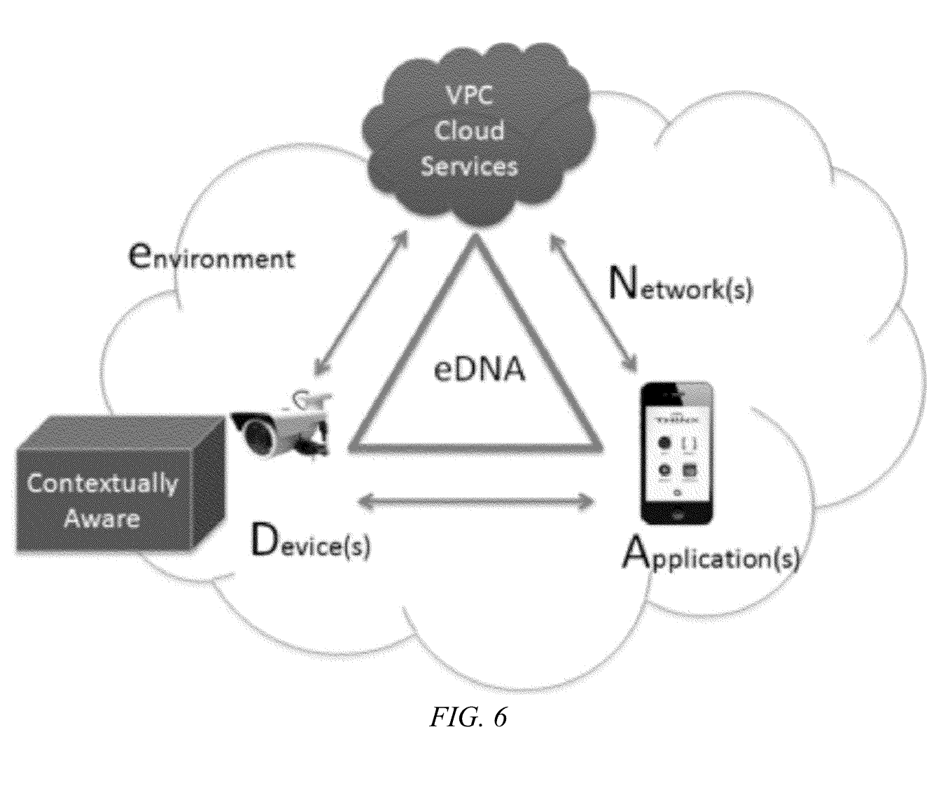

9) Here is the sequence of initialization, as also depicted by FIGS. 5A and 5B.

10) (step 502) Ensure the directories needed on the device are present.

11) (step 504) Ensure that the needed databases, for localized storage, are created and accessible.

12) (step 506) Initialize the Edge Device (Fuel Connection Manager) process; manage the Internet connection in the case of a wireless modem device.

13) (step 508) Start the Network Time Protocol (NTP) initializer. Time-based authentication tokens are used and so there is a need to keep time as close as possible amongst all servers and clients.

14) (step 510) If unable to perform a NTP sync, the application falls back to a failsafe process. This process will ask the Flint Service for the current time and time zone, (step 512) if the device has one set, and will use this information to (step 514) set the time on the device.

15) (step 516) Attempt a registration with mCloud. This registration process will only complete if mCloud has knowledge of the device. Once the device is verified the process will continue. With the registration request the device will send its state information so that mCloud or User can take action if required. The response is expected to be a configuration zip file download. This zip file will contain a custom properties file so that the device can be configured properly.

16) (step 522) Lastly the UC runs a process that will test to see if the device has been reset, if so tells mCloud to reset this device's configuration.

17) (step 524) After registration the device will use a time based authentication token. All data is received and sent using TLS to ensure data is not compromised.

### Logic Behind Open VPN Within Universal Cloud Connector

OpenVPN is an Open Source non IP-SEC VPN solution. This solution provides the ability to put devices, in any location, and have those devices become available to a cloud network. There are three separate parts of the implementation. mCloud, which hosts both the OpenVPN Servers and mTHINX Cloud Services. The clients can be any device or personal computer (“PC”) that has been setup with the OpenVPN application and either:

has the Fire Application embedded or

user has credentials to create/download the proper OpenVPN configuration files.

mTHINX Cloud Services

The cloud network hosts the master OpenVPN Server(s) that the devices connect to. Every device has had the OpenVPN application built specifically for the platform; users must obtain and install the proper OpenVPN application for their platform. The proper OpenVPN configuration comes from mCloud in a zip file, after proper authentication has been provided. The zip file contains the OpenVPN Configuration file and the certificate generated for the client. The certificates, both server and client, are generated using a custom install of an Enterprise Java Bean Certificate Authority (EJBCA), using EJBCA remote services. The zip also contains a MD5 hash file that contains the hash for each of the necessary files. This is so that files may be verified as complete after download. The cloud also provides a few other functions, discussed in further detail below. The process from a client perspective will be covered first, following by a server perspective.

OpenVPN Client Device

As stated earlier there is an OpenVPN build for each of the platforms that are supported. The Fire application is responsible for connecting to the cloud to request the appropriate OpenVPN configuration files. Once downloaded the zip file is extracted and tested to ensure all files are complete using the provided MD5 hash file. The Fire application is also responsible for ensuring proper connectivity, e.g. start/stop/restart operations. After the configuration has been downloaded and verified, Fire will start the OpenVPN process, using the provided configuration. On an interval the Fire application tests to ensure the correct network adapter is present; if not, it will re-start the OpenVPN process. If the network adapter is present, a test is run to ensure proper connectivity with the correct OpenVPN Server, will connect. If the server cannot be reached, over the OpenVPN network connection, the Fire application will restart the OpenVPN process.

OpenVPN Client User

The user must have their copy of OpenVPN installed and working The user must download the proper OpenVPN configuration zip file for their platform. The proper end points are available apron request. Once the user has the configuration file, they may create the connection to the OpenVPN Server. Most users will not need to use this functionality; however, it is very helpful for mTHINX Support.

OpenVPN Server

The OpenVPN Server is configured to do several things when a client requests a connection. First, OpenVPN will ensure the requesting client has the correct certificate key chain. If, and only if, the certificate is valid then it allows the connection process to continue. Once connected, the client is placed in isolation. Then the custom configuration takes over; this configuration is provided through an OpenVPN Plugin. The Plugin allows hooks into the event processes of OpenVPN, allowing specific routing of data between two end points. This enables User Clients to connect to Device Clients that are registered with them—or Devices that have been Shared with the User using a Cloud Service to configure. Once the client has been verified a file is created for the user, this file is how the data is filtered to specific end points—Client Filtering File. The process will ask the mTHINX Cloud Services to download a zip file containing any and all modified Client Filtering File's. The zip file is extracted to a specific location on the system to allow OpenVPN to read them, with any previous files being overwritten. Next, client specific information is sent to the mTHINX Cloud Services for record-keeping, then the client is assigned an OpenVPN IP address. This IP address will be sent down to a local DNS Server that maintains all OpenVPN IP's with the specific client; this allows other processes on the server to access clients—using a Common Name for the client. When the client disconnects, the Client Filtering File is removed, allowing connection metrics and client specific data to be sent to the mTHINX Cloud Services for record-keeping, e.g., duration of VPN connection, bytes sent and received, etc. and that the client is disconnected.

### Logic Behind MTHINX Cloud Services

The mTHINX Cloud Services, herein referred to as “Services”, provide all needed functionality for devices and clients. The Services are made up of a group of applications that work together to provide REST services, messaging services, realtime event data, realtime data aggregation, and video streaming services. Any data storage used is provided by MySQL RDBMS. The Services allow integrators to manage and maintain users, devices, device configurations, device events, snapshots, and video streams.

REST Services

The REST Services are provided in what are referred to as the Flint Service. The Flint Service is a set of REST API calls that enable clients and the mTHINX mobile application to access stored data and algorithms. Through the Flint Service there is access to the current state of users and devices, configuration of devices, device events, and video streaming. The Flint Service uses standard JSON objects through standard HTTP methodologies. All devices provide a time sensitive authentication token and so all devices must be running a network time protocol (NTP) client. Regular users must use standard HTTP Authentication. Any requests that perform device configurations are wrapped into a message and passed to the Flint Gateway. Some requests require a response, in this case the Flint Gateway sends the response message back.

Messaging Services

The Messaging Services are provided in what are referred to as the Flint Gateway. The Flint Gateway acts as a message bus between a device and the cloud. The messages are currently built and transmitted as JSON data over web sockets. A message can go from the client to the device in the form of the configuration/info request message, or a device to client message in the form of an event message. There is one other form of message: a reply to a configuration/info message. The messaging service communications are handled by the Flint Service when the request is a configuration or informational request.

The Flint Gateway also provides the ability to subscribe to event channels that provide real time analysis of raw event data. This can be used by integrators that are using sensor inputs to drive complex business decisions. There are predefined channels that provide aggregated data, and more channels will become available over time.

Video Streaming Services

The Video Streaming Services are able to provide a live stream in the form of RTSP URL's. To obtain a time sensitive RTSP URL, one may make a call to the Flint Service, after authentication. The Flint Service will, when a request is made for live stream, validate the user for the camera and then start up the live stream feed. This is done so that when the user tries to play the stream it will have had time to ‘warm up’ the live video stream. Currently, the video stream is retrieved via the OpenVPN network connection and relayed using a Wowza Media Server instance. The live stream can be viewed as desired for as long as is required. Many concurrent users can view a single device at any given time.

The ability to reconfigure the video stream settings to adjust for low bandwidth or high bandwidth situations allows users to adjust for proper functioning of a device for their unique situation.

Clients

Clients are integrators or end users, using mobile applications, or a supported device and drive the mTHINX ecosystem. Integrators build applications that allow end users to create accounts, register devices, and configure them (white label solution).

Client devices then provide data to the cloud based on the user configuration. The end users can then view the data that their device has generated.

There are also clients that only want to see aggregated data based on the device event data. In these situations, they may subscribe to event channels that are provided by the Cloud Services. They will then receive data already aggregated to their specification.

It is understood that the present invention may take many forms and embodiments. Accordingly, several variations may be made in the foregoing without departing from the spirit or the scope of the invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments.

1. A Universal Connector (“UC”) ecosystem comprises:
first and second encrypted communications stacks configured to supervise persistent connectivity with distributed data collection points within an Internet of Things;
a processor and memory for storing instructions executable by the processor for registering everything that interacts with the UC ecosystem comprising steps of:
requesting by devices participating on the first stack to be adopted by logging into a Cloud Service (the “knowledge” factor);
if validated as an ecosystem device, it is placed into the adoption process and proceeds to the next layer of authentication;
representing applications (mobile and web) on the second stack that continue the adoption process for the user/owner (the possession factor);
creating an account;
associating the device to the account created; and
if all authentication factors are confirmed, adopting and registering the device to the user/owner upon completion of the adoption process.
